(19) United States
(12) Patent Application Publication
(10) Pub. No.: US 2008/0027844 A1
(43) Pub. Date: Jan. 31, 2008

(54) System and Method for Organising and Operating an Electronic Account

(75) Inventors: Julian Little, Cremome (AU); Ian Winwood McKenzie, South Yarra (AU)

Correspondence Address: FISH & RICHARDSON P.C., P.O. BOX 1022, MINNEAPOLIS, MN, 55440-1022, US

(73) Assignee: On Q Technologies Pty Ltd., Eaglemont (AU)

(21) Appl. No.: 11/779,618

(22) Filed: Jul. 18, 2007

(30) Foreign Application Priority Data
Jul. 19, 2006 (AU) 2006903969

(51) Int. Cl. G06Q 40/00

(52) U.S. Cl. 705/35

(57) ABSTRACT

A method for a user to operate accounts with a user device when the user device is operably connected to a communications network, the user having at least one transaction account, the method including the steps of: (a) the user establishing any number of linked transaction accounts and associating same with the at least one transaction account; (b) the user establishing account operating rules for the at least one transaction account and any linked transaction accounts; and (c) the user operating a user device to access the at least one transaction account and/or any linked transaction accounts.

### FIELD OF THE INVENTION

The present invention relates to a system, method, computer software program, and uses thereof, for organising and operating accounts, the details and operation of which are available to user devices connected to a data communications network. The invention is particularly suited to organising an account into sub-accounts for specific purposes or types of transactions enabling a user to improve the organisation and operation of their accounts.

### BACKGROUND OF THE INVENTION

Increasingly, users seek to operate their financial arrangements in the most convenient manner without the requirement to physically attend a premises to effect a financial transaction. This is evidenced by the significant increase in users settling their accounts or invoices electronically by transferring funds from an existing bank account to the party to whom a debt is owed.

In this regard, “on-line” banking has arisen enabling users to pay bills and attend to settling invoices outside banking hours by accessing their funds on-line and effecting transfer of funds from their bank account to pay the outstanding debt. This is usually effected by a user accessing a website on a home computing workstation or accessing an Interactive Voice Response (IVR) system to direct the transfer of funds from their account to the account of an entity to whom a debt is owed.

However, users still find that it is necessary to attend a physical premises of their banking institution or an Automatic Teller Machine (ATM) in instances where they require cash as a large number of transactions are only able to be effected with the transition of cash. For example, purchasing low cost items from a convenience store or settling a personal debt with another individual usually requires a cash transaction as the entity to whom the debt is owed in these instances either does not have an electronic bank account into which funds may be deposited or the costs associated with operating an electronic bank account for such transactions does not warrant the use of such facility for the purchase of such low cost items.

Further, organising accounts and keeping track of on-line payments currently presents difficulties for users who have adopted present day on-line banking practices. In particular, on-line banking effected with a mobile phone or a personal digital assistant does not readily allow a user to obtain a printed copy of the details of the transaction(s) and this further exacerbates the problem for individuals seeking to keep track of their on-line transactions.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

Method of the Invention

In one aspect, the present invention provides a method for a user to operate accounts with a user device when the user device is operably connected to a communications network, the user having at least one transaction account, the method including the steps of:
(a) the user establishing any number of linked transaction accounts and associating same with the at least one transaction account;
(b) the user establishing account operating rules for the at least one transaction account and any linked transaction accounts; and
(c) the user operating a user device to access the at least one transaction account and/or any linked transaction accounts.

All of the accounts are preferably on-line electronic accounts, namely, accounts that may be accessed and operated by use of devices connected to a data communications network. Further, linked accounts that are associated with the at least one account may be established by a user for any purpose including the management of transactions of a particular type (e.g. transactions via a particular scheme such as Visa or MasterCard) or for transactions relating to a particular entity or group of entities including individuals. Of course, a user will require at least one account and may use that particular account for any purpose including use of that single account for all transactions. Although an increased benefit arises as a result of allocating transactions into different linked accounts, it is possible for some users to derive sufficient benefit from a single account according to the present invention. However, irrespective of the number of accounts established by a user, it is expected that only one of the accounts would include all the necessary detail that is required for the purpose of accurately establishing the bona-fides of a user accessing a system according to the present invention. Only storing the required user information in a single account and enabling all other linked accounts to derive any necessary user information by accessing same through a linking arrangement avoids repeated storage of user details in each and every account. Whilst it is important for accounts to be establishable by a user, embodiments of the invention include the facility for user accounts to be established by other entities such as an entity that would usually invoice a user or an operator of a system according to the present invention.

As individual linked accounts need not be restricted to accounts relating to monetary transactions, a user could establish a linked account to organise and manage transactions that give rise to points, or any other item of value that is allocated to a user as a part of a loyalty scheme in return for purchases from preferred merchants. For example, a user may regularly receive frequent flyer points awarded by an airline for the purpose of encouraging greater patronage of the services of that airline and a user may establish a separate linked account for the purpose of receiving and storing the loyalty points awarded by the loyalty scheme provider. In addition to arbitrary points, loyalty schemes could provide allocations of other items of value such as litres of fuel or weight of goods that may subsequently be claimed from a participating merchant and/or converted to some other item of value such as a monetary value.

The account operating rules may be established by a user in the first instance or may be established as a result of modifying or accepting a default set of rules that are initially applied to newly established/created accounts. Similarly, one or more default linked accounts may be provided for a user by an operator of a system or another entity that is afforded such authority by the system operator and the user. Such linked accounts are effectively auto-created for the user and may be created as a result of the user requesting a particular type of linked account or a linked account for a particular purpose. In one embodiment, the account operating rules may be established and/or amended by operation of the user device.

In embodiments of the invention, the account operating rules are used to allow or disallow transactions with respect to the at least one account or one or more of the linked accounts (e.g. transactions that would effect a withdrawal from a loyalty account in the form of cash via a transfer of value to a scheme enabled account may be disallowed). In one embodiment, account operating rules are established to control intra-account transfers (i.e. transfers between accounts owned by the same user) and inter-account transfers (i.e. transfers between accounts belonging to different users). Account operating rules may also be established to control any transfer between accounts where the value of units in the respective accounts are of a different type. For example, frequent flyer points may be convertible to monetary units at a particular rate and an account operating rule may be established to determine accounts to which points can be transferred subsequent to conversion of the points to the type of value unit of the destination account. In another example, a user may be prevented from transferring loyalty scheme points into a scheme enabled account of another user.

In another embodiment, certain account operating rules (or types of rules) may be established by third parties and applied to one or more accounts. An example of the establishment and application of an account operating rule by a third party would be the instance of applying a conversion rate for loyalty scheme points that would initially be set by the loyalty scheme provider and changed from time to time in accordance with offers, or perhaps in accordance with a marketing campaign, to encourage greater patronage during a particular period of time with members of the loyalty rewards scheme. In this instance, the loyalty scheme provider would apply an account operating rule, or amend a rule applied by the user, that established the conversion rate of loyalty scheme points such that any transfer of loyalty scheme points from a particular account would occur at the conversion rate set by the loyalty scheme provider. Other types of rules can be implemented for a range of purposes such as enforcing statutory or regulatory requirements or even sophisticated rules for collecting information relating to transactions over significant periods of time for the purpose of identifying trends and highlighting the potential for future cash-flow problems for a user.

In various embodiments, the user device is any device operable to connect with, and transfer data over, a communications network. Although additional appropriate devices may be developed in the future, at this time the most likely user devices include desktop and/or laptop computers, personal digital assistants and mobile or cell phones that wirelessly connect to a communications network. Further, any appropriate form of communication with the data communications network is envisaged although the particular user interface and/or data communications network interface is susceptible to change with improvements over time. Presently, the most relevant and readily available interfaces include user devices operable to connect with the data communications network with a web-enabled interface, an Interactive Voice Response (IVR) system, Short Messaging Service (SMS), Multimedia Messaging Service (MMS) and similar interfaces provided with present day user devices.

In one embodiment of the invention, one of the user's accounts is associated with an account identification device. An account identification device includes a swipe card, smart card or any other device operable to retain and render an account identification number to an appropriate device operably connected to a communications network that can access an electronic account. Further, in this embodiment, funds are retained in the account for transfer to other accounts or to fund purchases or payments. In this embodiment, the user can credit funds into the account for subsequent distribution to other linked accounts thus enabling the user to manage funds that are credited into any particular account (either by themselves or a third party) and to distribute those funds to the most appropriate linked accounts in view of the individual requirements of the user. For example, a user may establish a linked account for the purpose of making regular payments in accordance with a loan agreement or payment for a utility service and may elect to receive income payments into an account and regularly distribute funds from that account to the linked account from which regular deductions are made to satisfy loan repayments. Alternatively, a linked account could be established with an operating rule that transfers funds from a user's account to make a payment when the payment becomes due. In one embodiment, the value is transferred into the linked account from which a payment is made In another embodiment, the payment is moved from another account (in accordance with the operating rule) and a record of the payment transaction is included in the account in which the payment operating rule resides. In yet another embodiment, an entity requiring payment for goods and/or services directly debits an account when a payment becomes due and the user established account operating rules may allow or disallow direct debits from external parties.

In some embodiments, a record of transactions for all accounts are retained and the method of the transaction is also recorded thus providing a user with a complete history of the transactions pertaining to any particular account. Further, in accordance with regular account keeping practices, it is preferable that an up to date balance for each account is retained for ready access by a user. In one embodiment, account balances are obtained by the user transmitting an SMS message to a system provider requesting an account balance and subsequently receiving an SMS message including the balance of the account. In an exemplary embodiment, the balance of the account could be either that of the user or a third party where third party access requirements have been satisfied. For example, access to a third party account balance could be established by appropriate account operating rules. Further, the balance of any account could be stored locally or could be determined as a result of interrogating a third party database.

In another aspect, the present invention provides a method for a user to effect account transactions wherein the user has previously established at least one transaction account and any number of linked transaction accounts, and associated same with the at least one transaction account, the method including the steps of:
(a) the user establishing account operating rules for the at least one transaction account and/or any linked transaction accounts; and
(b) arranging at least one transfer of value to at least one account; and
(c) causing at least one transaction to occur in accordance with at least one account operating rule.
   System of the Invention

In another aspect, the present invention provides a user operable account transaction enabling a user to access at least one transaction account with a user device, the at least one transaction account including links to any number of linked transaction accounts, the system including:

a user communication network gateway operable to provide network access to user devices;

a data storage means operably connected to the communication network for storing the user's account details, the links therebetween and operating rules for each account; and

at least one computer instruction processing device that receives a user account transaction request and executes same in accordance with at least one account operating role.

The system will usually require administration by a system operator and accordingly, the system may include a system operator communication gateway providing network access to a system operator for the purpose of administering the user accounts and effecting usual account procedures such as establishment, closure and resolving any queries regarding transactions. Any component of the system could reside in any country where a global communication network is employed

In an exemplary embodiment, a system operator pools all of the available funds of the accounts that are managed by the system into a single operating account whilst retaining an accurate balance of the individual user accounts. This arrangement enables the system operator to effectively manage all of the funds that are credited to the individual accounts.

Computer Software Program Code for Implementing the Method of the Invention

According to a further aspect, the present invention provides a computer program enabling a user to access a transaction account with a user device when the device is operably connected to a communications network, the transaction account including links to any number of linked transaction accounts, the computer program including:

computer instruction code providing access to a communications network for the user's device;

computer instruction code for authenticating the user accessing the network and upon successful authentication, providing the user with access to their transaction accounts;

computer instruction code enabling the user to establish or amend any account operating rules associated with any one or more of their transaction accounts; and

computer instruction code enabling the user to effect account transactions and applying the relevant account operating rules with respect to any accounts involved in the transactions.

The computer instruction code may result in computer instructions that are implemented integrally to a computer or of a network of computers using separate software components. The code may also include components of existing software that effect functions in cooperation with dedicated code developed specifically for the present invention.

Apparatus of the Invention

In another aspect, the present invention provides a user communication network gateway operable to provide access between user devices and at least one data storage means that includes details pertaining to a user's at least one transaction account, any number of linked transaction accounts and operating rules pertaining thereto, wherein the communication network gateway provides access for users to effect transactions with respect to their at least one transaction account and/or any number of linked transaction accounts in accordance with any applicable account operating rules.

In another aspect, the present invention provides an operations server for effecting transactions in respect of a user's at least one transaction account and any number of linked transaction accounts, the operations server being connected to a communications network that is operable to receive user instructions in respect of their transaction account and/or any linked transaction accounts, said user instructions being effected in accordance with account operating rules that are associated with their transaction accounts.

A Mobile Communications Device

In another aspect, the present invention provides a mobile communications device when used to access a transaction account the mobile communications device being operably connected to a communications network, the transaction account including links to any number of linked transaction accounts establishable by the user, the mobile communications device operable by the user to effect any one or more of the following:
(a) establishing linked transaction accounts and associating same with the at least one transaction account;
(b) establishing account operating rules for the at least one transaction account and/or any linked transaction accounts; or
(c) accessing and effecting a transaction involving the at least one transaction account and/or any linked transaction accounts.

In an exemplary embodiment, the mobile communications device is a mobile phone and the step of accessing a transaction account is effected by use of the SMS data messaging system. In other embodiments, the mobile communications device is a notebook computer or a personal digital assistant that is operated by a user to transmit data to access and operate their accounts.

Method of Offering Organised Accounts to Consumers

In yet a further aspect, the present invention provides a method of offering a pre-established transaction account to a user, the transaction account accessible to the user by use of a user device when operably connected to a communications network, the method including the steps of:

establishing at least one transaction account for the user including identifying details pertaining to the user;

establishing default account operating rules that apply to the transaction account that are amendable by the user; and

forwarding an offer to the user to use of the transaction account.

By establishing a user account on behalf of the user and associating a set of account operating rules to accompany the account, a user is able to avail themselves of the account whilst avoiding the time and effort that would otherwise usually be incurred to arrange the establishment of an account with appropriate account operating rules.

In an exemplary embodiment of the invention, an account system operator may bulk issue accounts to an entity that regularly invoices users for their services, such as a utility supplier or a franchised garden maintenance service, and that entity may forward to their users a user identification device that identifies a linked account that is established to manage and assist the payment of invoices to the entity. For example, an electricity supplier may establish accounts for all their customers with a default set of account operating rules and may also arrange the generation and supply of swipe cards (identification devices) for each of their customers that act to identify the user and the pre-established account.

Upon receipt of the swipe card and the pre-established account arrangement, users may then effect settlement of invoices raised by the electricity supplier by transferring funds to the account associated with the swipe card. This settlement may be effected by a transfer of funds from another account owned by the user or alternatively, the user may approach any device connected to a communication network where that device enables them to credit funds to an account and upon presentation of the swipe card may transfer funds to an account with a scheduled debit arrangement to effect settlement of the electricity supplier's invoice.

### BRIEF DESCRIPTION OF THE DRAWINGS

Embodiments of the invention are now described with reference to the accompanying drawings, in which:

FIG. 1a is a diagrammatic representation of an electronic account structure including an account with various associated linked accounts that have been established for specific purposes;

FIG. 1b is a diagrammatic representation of the primary system components of an embodiment of a system operable to effect various methods according to the present invention;

FIG. 1c is a diagrammatic representation of the primary system components of an embodiment of a system that operates a regular payroll distribution arrangement;

FIGS. 2a and 2b are flow charts detailing the method steps associated with transferring value into an account and attending to payment of an invoice;

FIG. 3 is a flowchart detailing the method steps associated with an entity to whom a debt is owed seeking payment for an invoice from the account of a user who owes the debt, the method including either the user electing to pay the debt or alternatively being notified of an automatic processing of a debit at some time in the future;

FIG. 4 is a flowchart detailing the method steps associated with the transfer of value from an account of one user to an account of a second user (referred to as an inter-account transfer);

FIG. 5 is a flowchart detailing the method steps associated with the transfer of value from a scheme enabled account (such as Visa or MasterCard) to another account owned by the same user where the destination account for the transfer of value has a specific characteristic (referred to as an intra-account transfer);

FIG. 6 is a flowchart detailing the method steps effected by a system that provides for the operation of an account structure according to the invention wherein an account dedicated to receiving loyalty scheme points is monitored by the system and value accumulated in the loyalty scheme account is transferred to another linked account owned by the user in accordance with a pre-established account operating rule.

### DETAILED DESCRIPTION OF AN EXEMPLARY EMBODIMENT

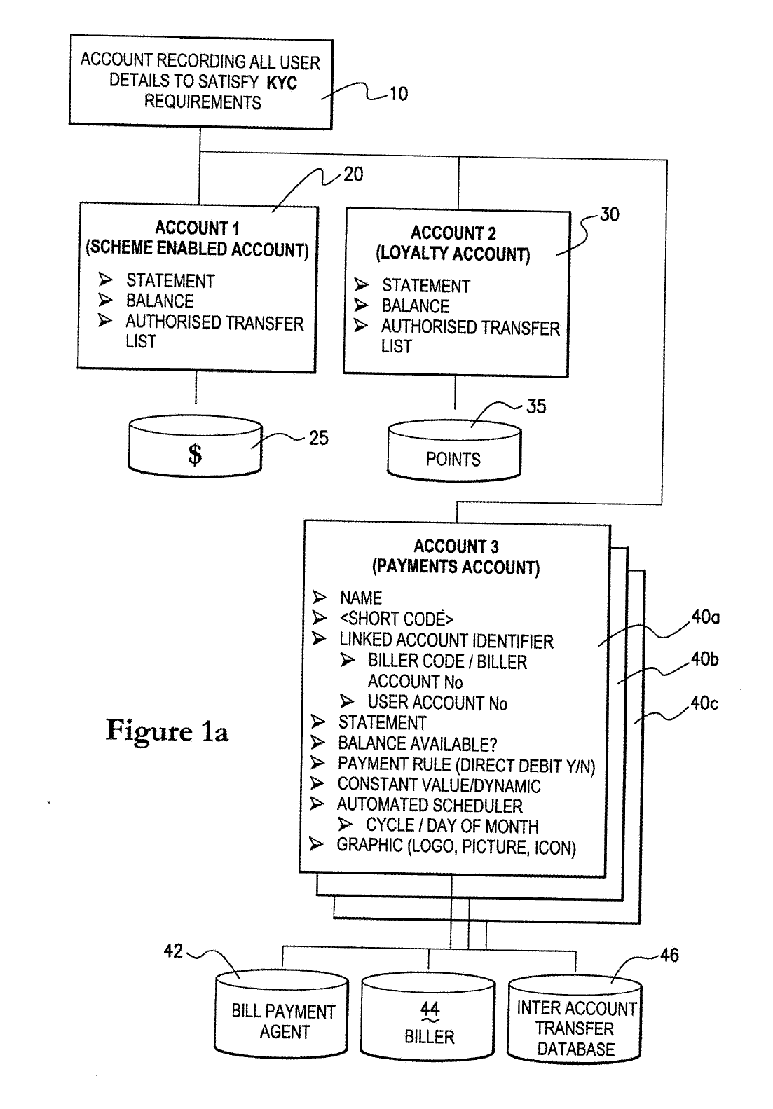

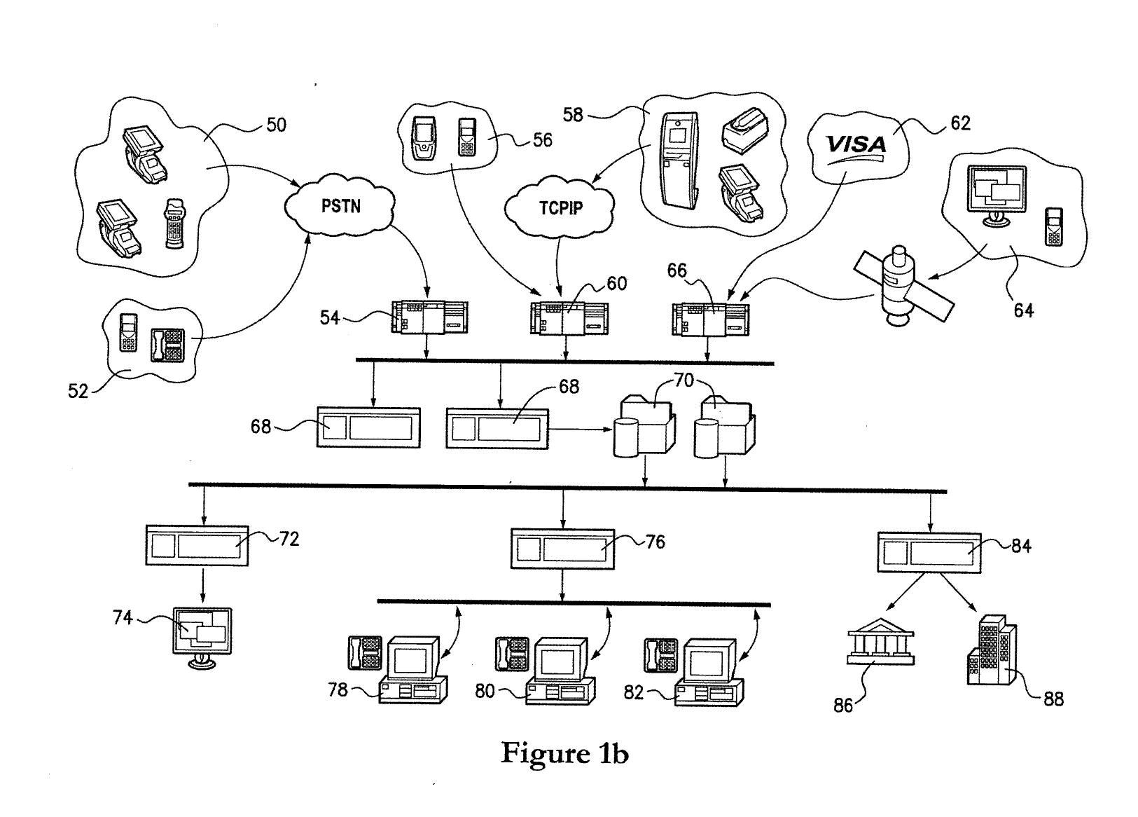

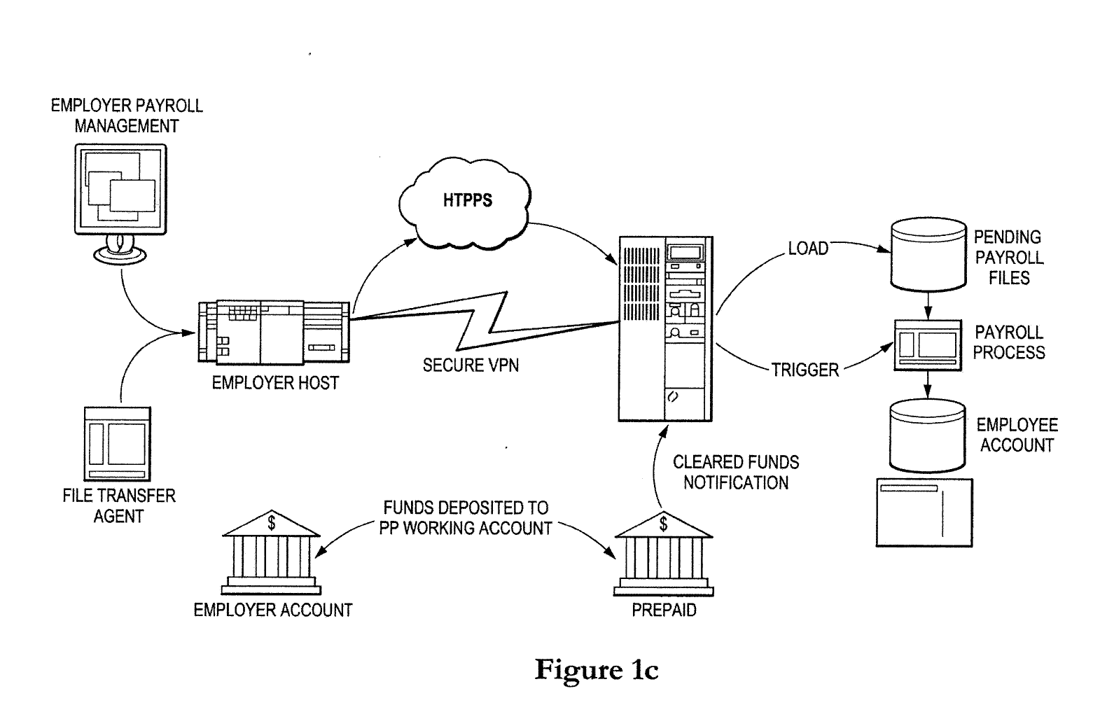

FIG. 1a provides a diagrammatic representation of an account (10) and the association of that account with three linked accounts that have been established by a user in accordance with the user's individual requirements. In the particular instance of the example in FIG. 1a, linked account 1 (20) has been established to organise and manage transactions relating to an account that accords with a particular scheme such as Visa or Mastercard which enables transactions to be effected by any device connected to the Visa, Mastercard or scheme enabled network. Of course other scheme enabled accounts may also be established depending upon the scheme that a user considers the most convenient for their requirements provided multiple schemes are enabled by the system operator. Linked account 2 (30) has been established to manage the award and expenditure of points in relation to a loyalty scheme and linked account 3 (40) has been established for the payment of bills or invoices, payments to third parties, or inter account transfers.

The account (10) preferably includes sufficient customer details to comply with the “Know Your Customer” (KYC) requirements and should include as a minimum the customer's full name, address and other contact details such as mobile phone number, email address, etc. Where accounts are linked to this account (10), it is not necessary for those linked accounts (20, 30, 40a, 40b, 40c . . . ) to retain the detailed KYC information. Further, different aspects of this recorded customer information may be used for identification purposes. For example, rather than provide the customer with a unique identification number for identification purposes, various components of the customer's details may be used for identification purposes. Alternatively, in one embodiment, the customer's mobile phone number may be used to identify the relevant account for a transaction. In this particular embodiment, the means by which the user elects to access the system is also the means by which the user and the user's account details are identified. Authentication of a customer for the purpose of allowing a transaction to be effected may be implemented by a range of alternatives or additional requirements such as a PIN or a password.

In addition to establishing the various linked accounts, the user also establishes account operating rules and associates those rules with each of the accounts. In the example of FIG. 1a where linked account 1 (20) relates to transactions effected by the user in accordance with a particular scheme enabled account, the user may include, or the system operator may define, a range of account operating rules such as:
only allowing funds in the account to be used for particular purposes;
only allowing funds in the account to be used for purchases from a pre-defined list of approved merchants;
only allowing funds to accumulate to a particular balance and transferring the excess to a pre-defined nominated linked account;
only allowing access to the funds in the account to the user or a pre-defined list of approved users (or other entities) with maximum daily withdrawal amounts for each user in the pre-defined list;
performing pre-arranged and pre-defined transactions, for example, to satisfy loan repayments on a regular basis; or
pre-defined time delay for access to value in an account.

Linked account 1 (20) is associated with a database (25) that preferably retains a record of all transactions associated with the scheme and maintains a current balance with respect to the available funds at any point in time. Further, transfers of funds to and from linked account 1 (20) would only occur in accordance with the account operating rules and any requested transfer that did not accord with the account operating rules would not be allowed to transfer funds to or from the linked account.

Linked account 2 (30) relates to a loyalty scheme and in establishing this account, the user could establish, or the system operator may define, account operating rules such as:
only allowing a pre-defined list of authorised users to access loyalty value from the account (e.g. family members);
only allowing loyalty value to be used for a restricted set of purposes (e.g. not transferable to cash);
only allowing extraction of loyalty value when the loyalty value balance is above a defined threshold;
establishing the conditions upon which an alert is sent to the user to advise them of the loyalty value balance or the availability of a promotional offer for the conversion of loyalty value for goods and/or services; or
establishing the conditions providing the loyalty scheme operator access to the account, to the account operating rules or receiving data regarding details of the account;

Linked account 2 (30) is associated with the loyalty points database (35) in which a current balance of the loyalty points available to the user is retained. Preferably, the loyalty points database (35) also retains a complete history of all transactions relating to the linked account (30) including the award of loyalty value to the linked account and the extraction of loyalty value therefrom and the details of the extraction of value.

Linked account 3 (40a, 40b, 40c . . . ) is a range of accounts established for the purpose of managing payments. These accounts may be used to effect payments to entities for the purpose of settling an outstanding bill or invoice or alternatively, this type of account could be used to transfer credit to an account owned by an individual. For example, a father or mother may establish such an account to enable them to effect a transfer of credit to a son or daughter. In any event, these accounts are associated with a bill payment agent database (42), a biller database (44) or an Inter Account transfer database depending upon the purpose of the account. In the particular instance of the exemplary embodiment of FIG. 1a, with a linked account of this type, the user would likely establish, or the system operator may define, account operating rules such as:
only allowing payments to be made to approved entities for which an account has been established;
only allowing payments to be made if there are sufficient funds available in the account (or another linked account) to settle the invoice in total and any user payable transaction fees;
only allowing payment of an invoice if the invoice amount is below a pre-defined threshold;
only allowing payment of an invoice if permission is granted by the user;
only allowing a direct debit to be established by the user for direct debit payment arrangements;
providing a notification of an imminent direct debit by SMS, the advance notification period as pre-defined by the user; or
allowing a third party to transfer value into the payment account.

Each account, or account type, may include information that is relevant to the efficient operation of transactions with respect to that account. For example, the payment accounts (40a, 40b, 40c . . . ) may include information identifying the “Name” of the account, a “<short code>” that identifies the account with an abbreviation (such that would be useful for transmitting in an SMS message), a “Linked Account Identifier” that could either be in the form of a “Biller Code/Biller Account No” or a “User Account No”, a “Statement” flag indicating whether the account can provide a statement, a “Balance Available?” flag to indicate the availability of a balance amount, a “Payment Rule” indicating the rule that applies to making payments and in particular, whether a “Direct Debit” arrangement is to be allowed for the transfer of credit out of the account. Also, these accounts could include a “Constant Value/Dynamic” flag to indicate whether any payment to be effected from the account according to a direct debit arrangement will relate to a constant amount each time or whether the amount will vary dynamically and an “Automated Scheduler” flag with additional data indicating the “Cycle/Day of the Month” that scheduled payments will be made in the event that an automated schedule is selected. Further, the account could also include a “Graphic” in the form of either a logo, picture or icon that could be particularly useful in the event that a user is effecting transaction with a graphical user interface that is able to identify individual accounts with a graphic that allows relatively easy identification of the accounts.

FIG. 1a provides a diagrammatic representation of an account linked with three particular types of account that a user could establish for managing transactions in relation to a scheme such as Visa or Mastercard, transactions relating to a loyalty scheme and transactions relating to payments. However, further examples of types of linked accounts are as follows:
a gaming account for the purpose of tracking all transactions relating to gambling activities including the receipt of winnings and the award of loyalty reward value;
a youth account to track payment of pocket money or gifts to a child;
an income account into which salary or drawings are transferred on a regular or ad-hoc basis;
a charity account that allows a user to transfer value into the account for the purpose of donating to charity and maintaining a record of all the transactions relating to donations to charity;
special purpose accounts such as holiday accounts or Christmas accounts where the user proposes to transfer value over time to save toward a particular purpose;
a high interest account into which excess funds are transferred for the periods of time where these funds are not required for any particular purpose and would otherwise not attract a rate of return if they were to remain in one or more of the other established accounts.

In the instance of a business that makes regular payroll payments to the income accounts of employees, the business may elect to establish an account for the purpose of making such regular payments to their employees. For example, the business could establish an account operating rule that transfers the requisite payroll payments from a business account into a payroll account that includes account operating rules that transfers individual amounts to their employee's income accounts. Given that payroll transfers could result in a significant amount of funds being transferred, it is preferable for an account system operator, who is effectively acting as an intermediary to the financial transaction, to introduce a delay between the transfer of payroll funds to an employee's income account and the availability of those funds to the employee. Of course, this arrangement could apply to any significant financial transaction and the delay would only need to be sufficiently long for the account system operator to be sure that they have received the funds pertaining to the financial transaction(s) before making funds available to the recipient(s). This type of account operating rule would most likely be implemented by the account system operator in order to protect the cash flow of the entity that operates the account system. FIG. 1c provides a diagrammatic representation of the primary system elements in an arrangement for transferring payroll entitlements to employees where the account system operator awaits notification of cleared funds for all the individual employee transactions before proceeding to credit the individual employee accounts.

In addition to users applying account operating rules to their individual accounts, the account system provider may also apply account operating rules for various purposes including;
Rules to ensure compliance with regulatory requirements;
Rules to reduce the incidence of fraud or risk; and/or
Rules to limit the exposure of users to adverse operations with respect to their on-line accounts.

In the instance of ensuring compliance with regulatory requirements, there are various requirements in countries around the world regarding the maximum allowable balance retained within an account for any particular user depending upon the extent to which that user has adduced evidence of their identity to the account operator. For example, in some countries, a 100 point check is implemented by account operators to determine the true identity of a user seeking to qualify to operate one of their accounts. The 100 point assessment usually involves the user obtaining merit points toward proving their identity by adducing documents such as birth certificates, driver's licenses, passports etc to the account operator. In the event that a user can adduce sufficient documentary evidence to achieve 100 points, they are considered to have proven their identity and will then be allowed to have account balances exceeding a pre-defined threshold. However, for users that have either failed to achieve the necessary 100 points or have yet to adduce the necessary documentation to the account operator, they will not be allowed to accrue a balance in all their accounts that exceeds the pre-defined threshold. Account operating rules may be implemented by the account system operator to indicate the status of a user with respect to the 100 point assessment and to prevent any transaction that would accrue a total balance for that user beyond the allowable limit. Similarly, an account operating rule could also be implemented to provide an alert to the account system operators identifying any disallowed transaction and the reason for the prevention of that transaction from being effected. This information may then be passed on to appropriate statutory or regulatory authorities for further investigation. Compliance with other types of regulatory requirements can also be accommodated such as preventing users under the age of 7 from having a scheme enabled account such as those that can be accessed by network devices connected to either the Visa or Mastercard networks.

For the purpose of reducing the incidence of fraud or risk, or to reduce the exposure of users to adverse transactions, the account system operator may implement account operating rules that limit account activity such as:
preventing transactions with respect to the same user account (or a linked account) of a user that are initiated from different countries within a pre-defined period of time;
preventing more than a pre-defined number of types of transactions with a specific period of time (e.g. preventing more than 5 ATM debit transactions within a 12 hour period);
preventing transactions that involve a debit from an account that originate from particular countries or continents (e.g. Russia or Africa);
preventing withdrawal of value from a user's accounts (including all linked accounts) that exceeds a pre-defined threshold in any 24 hour period; and/or
preventing transfer of value to a linked gaming account beyond a pre-defined threshold within any 24 hour period.
   Of course, the user of a transaction account system according to the present invention may be a business entity rather than an individual. In this instance, the account operating rules required by a business would usually be different as compared with those for an individual and hence the default rules may be tailored depending upon the type of entity for which the accounts are being established. For example, businesses are usually concerned about cash flow and ensuring that they have enough funds to cover forthcoming debts as and when they fall due. In this respect, an account operating rule may be implemented that keeps track of all income and expenditure across all the accounts of a business entity in order to predict any potential cash flow problem that could arise in the future. Of course, this type of account operating rule would also be useful for an individual and could assist them from making a purchase or incurring debts that could give rise to a cash flow problem. Rules of this type could be implemented by an account system operator as an additional service in an attempt to encourage users (businesses and individuals) to establish accounts and conduct all their transactions in accordance with those accounts to better enable them to keep track of their cash flow requirements and potential future problems. This particular arrangement assists the proactive marketing of consumer loan offers that could be transmitted to a user by SMS.

Throughout the description of exemplary embodiments of the invention, there are numerous references to effecting transactions by use of SMS messaging as this arrangement is presently one of the most widely available arrangements for conveniently transmitting data at a reasonable cost. Of course, as will be recognised by persons skilled in the relevant field of technology, the SMS arrangement may be superseded by widespread implementation of alternative data messaging arrangements that provide similar or improved data entry and transmission arrangements as compared with SMS. For example, WAP (Wireless Access Protocol) or IP Messaging for handheld/portable devices may eventually provide similar data transmission capabilities with improved user interfaces as compared with SMS text via mobile phone for a cost that renders SMS messaging obsolete. Therefore, although the exemplary embodiments include references to the use of SMS messaging it should be recognised that any alternative data messaging arrangement could equally be used for the purpose of implementing the invention.

FIG. 1b is a diagrammatic representation of the primary system elements of an embodiment of a system according to the present invention. With reference to FIG. 1b, various client and service provider gateway servers (54, 60, and 66) are provided as an interface for clients and service providers. Gateway 54 is connected to the Public Switched Telephone Network (PSTN) and provides connectivity to retail service providers (50) who require access to the system by way of a dial up network access. Access to the system through the PSTN is also provided to interactive telephony services (52).

A gateway server (60) provides connectivity to mobile telephones and personal digital assistants (56) and also provides a Transport Control Protocol / Internet Protocol (TCP/IP) interface for the connection of various retail TCP/IP network devices (58). Gateway server (66) provides access to the system from devices connected to the global Visa or scheme network (62) and various consumer network devices including Voice Over Internet Protocol (VOIP) telephony devices (64).

All of the various network devices connected to the system allow various entities to effect transactions involving on-line electronic accounts that are administered by the system. Data storage devices (70) are connected to the account system network to store the account details of all of the users and the links between accounts. Account logic and rules servers (68) are also connected to the account system network and process all requested transactions from any connected network device.

The data storage devices (70) are connected to an account administration network to enable administration of the user of the stored user accounts. An account web services server (72) provides access to the account administration network by a range of entities requiring access to the account administration network by way of the world wide web (74). Account management servers (76) are also connected to the account administration network enabling various system operations to be effected with respect to the stored user account data. For example, call centre support operators (78) are connected to the account administration net work to enable them to address queries relating to the stored detail of user accounts on the storage devices (70). Further, operations support (80) is also connected to the account administration network for system operators to effect any necessary functions. Additionally, administration operators (82) are also connected to the account administration network to effect any necessary administration tasks.

As transactions effected between user accounts may require the transfer of value from external account systems, an account settlement processing server (84) is also connected to the account administration network. The account settlement processing server (84) provides connectivity and data transfer between the online account system and external entities such as banks (86) and external suppliers/partners (88).

Users will most likely require access to their account operating rules to include amendments to same and such access is envisaged to occur primarily through a web service. It is also likely that users would prefer to use a web based interface when establishing new accounts and/or when seeking to review the history of transactions that have occurred in any particular account. However, when seeking to effect transactions, users are likely to prefer to use a more mobile device such as a mobile telephone which usually does not include a web based interface. In any event, an advantage of linking accounts is the ability to provide users with a listing of their accounts each and every time they seek to effect a transaction, irrespective of the particular interface used by the user. For example, when seeking to transfer funds from one account to another, having established and linked various accounts, an account system operator may present to the user a full listing of all their accounts enabling them to select a particular account as the source or destination account for the transaction. This is particularly useful where the interface has a graphical component enabling the account system operator to display to the user graphical objects representing each of their individual linked accounts and thus only requiring the user to select one of the graphical objects to indicate the account for which they require an action to be performed.

This particular advantage is in addition to the advantage of enabling a user to establish account operating rules that effect actions or transactions with respect to linked accounts automatically without further action on the part of the user.

Examples of Operations of the linked Account System

A significant advantage of structuring on-line accounts in accordance with the invention with the inclusion of specific and tailored account operating rules for individual accounts is the flexibility afforded to a user for day to day operation of their accounts and allowing them to quickly and efficiently achieve their objectives and purposes.

The following examples provide an indication of the flexibility and efficiency of implementing specific actions that users would most likely effect from time to time.

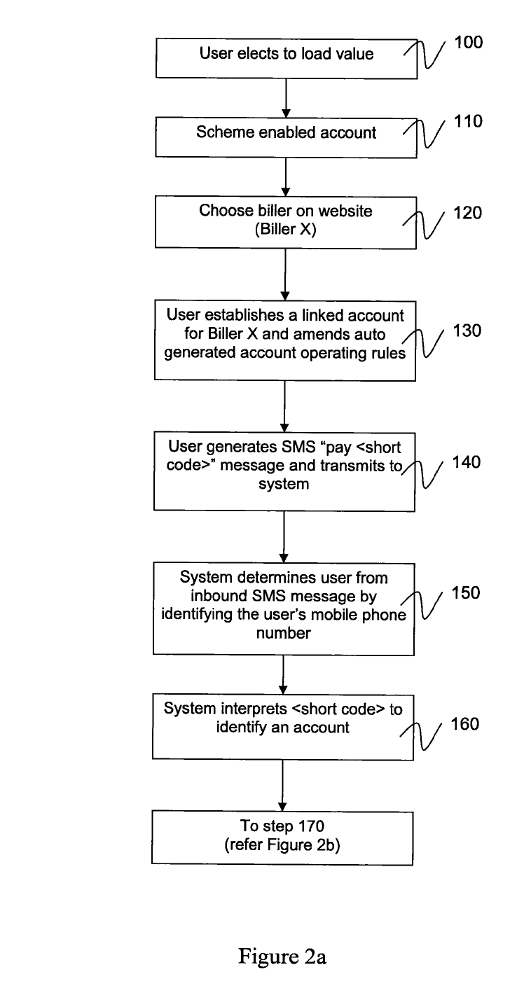

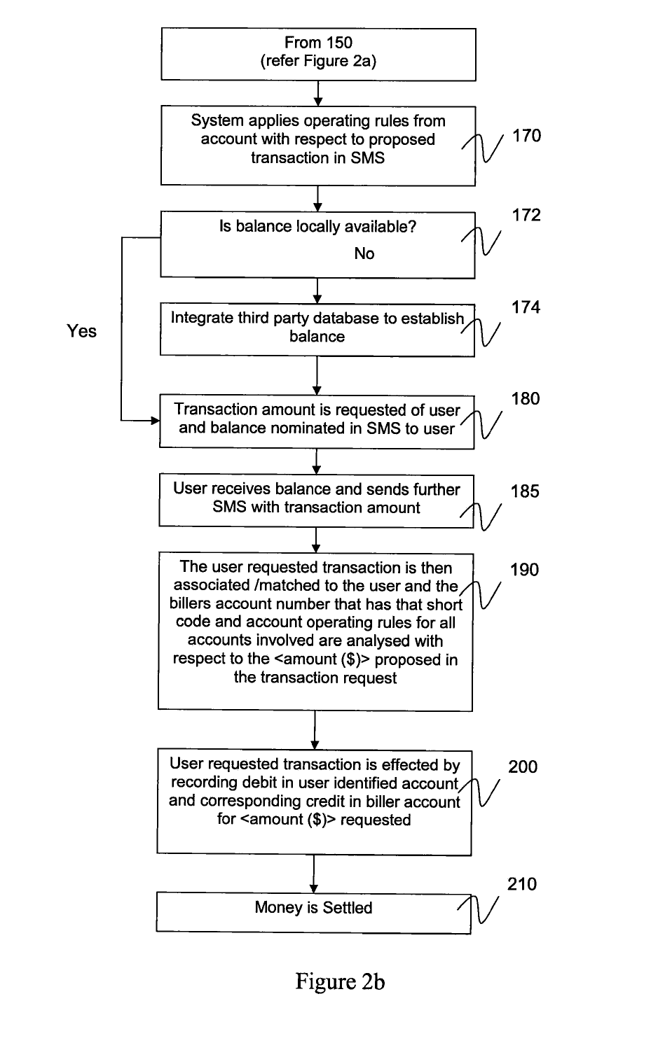

FIGS. 2a and 2b provide an example of an inter-account transfer where a user loads value (step 100) into an account (such as a scheme enabled account that can be accessed via the Visa or Mastercard network) at step 110 and elects to pay an invoice that has been issued by biller X (step 120). In the particular instance of the example detailed in FIG. 2a, the biller is located and selected by a web-site (step 120).

At step 130, the user establishes a linked account for Biller X and the particular Biller account No that relates to the services consumed by the user. The linked account is created by the account system operator and is accompanied with a set of default account operating rules. The user may elect to amend those default account operating rules to accord with their own personal requirements. For example, for certain bills or invoices, the user may elect to allow a direct debit arrangement wherein the account system operator or the biller is authorised to directly access credit within the user's account. Of course, the user may also establish a range of other linked accounts for entities with whom they regularly incur debts or for entities to whom they wish to transfer credit.

Over time, the user is likely to receive an invoice and at step 140, the user elects to pay the invoice by transferring funds from an account having value to the linked account for effecting payments to Biller X for the particular services provided by the Biller. In the particular example of FIG. 2a, the user elects to effect the funds transfer to settle the invoice by SMS. Accordingly, at step 140, the user generates an SMS message “Pay <short-code>” and transmits same to a telephone number that is connected to an SMS device that is interfaced to the account operating system.

At step 150, the system determines the identity of the user by comparing the source telephone number of the SMS message with the records relating to all users and locates the users account. In this particular example, the telephone number also identifies the source account from which the user requires funds to be transferred although the user could identify another linked account for this purpose. The <short-code> is an abbreviation that is used to identify the linked biller payment account and at step 160, the account operating system receives the SMS from the user and interprets the <short-code> to determine the identity of the biller and the biller/invoice.

At step 170, the account operating rules of both the source and destination accounts are applied by the system. At step 172, the system determines whether an account balance is available for the relevant user payment account. If not, then a third party database is interrogated (step 174) to determine the balance of the payment account. The process then proceeds to step 180 (which also occurs if an account balance is determined to be available at step 172) and a transaction amount to be transferred from the source account to the destination account is requested in addition to supplying the user with information pertaining to the balance of the payment account. This request, and the information pertaining to the balance of the account, is provided to the user in the form of an SMS message.

Upon receipt of the SMS message by the user and generation and transmission of a reply that includes the amount to be transferred (step 185), the account operating system then applies the remainder of the account operating rules of all accounts involved in the transaction (step 190). The reply from the user detailing the amount to be transferred is taken as a confirmation from the user that they authorise the transaction to proceed.

At step 200, the user requested transaction is effected by recording a debit in the user identified source account and a corresponding credit in the user identified destination account for the amount ($) detailed in the SMS message. Some time later, at step 210, the linked biller payment account is debited by the account operating system and funds are credited to a pre-determined account of the biller with settlement data pertaining to the bill details transferred from the account operating system to the biller host.

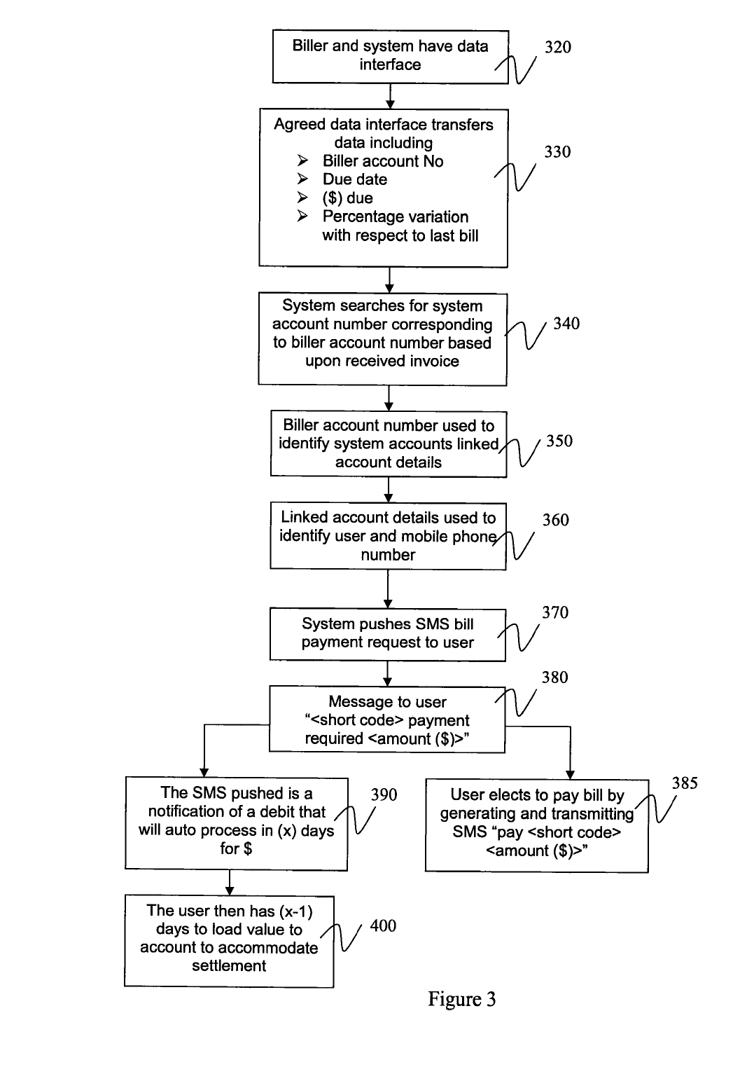

With reference to FIG. 3, a more sophisticated bill payment arrangement is enabled wherein the biller and the system that operates the account structure have an established data interface for transferring biller data relating to the payment of bills due to be paid (320) from the biller host to the account operating system host.

In this particular embodiment, the data interface transfers data (330) including the biller account number, the due date of the bill, the amount that is due and provision for a flag to indicate that the appropriate amount has been transferred from the user's nominated account to settle the bill. The particular embodiment of FIG. 3 also includes data that indicates the percentage variation of the outstanding invoice with respect to the previous invoice.

Upon receipt of a request to pay a bill, or for a bill to be paid, the system at step 340 searches for the system account number that relates to the biller or biller's account number in the request. Having matched the details of the biller/biller's account number in the data transfer with the corresponding system account number at step 350, the system then identifies the linked user account of the user who has incurred the debt and the user's mobile phone number (step 360). In the example of FIG. 3, the biller generates the request for the payment of the invoice and transmits the data to the system (370). The system then generates an SMS message and transmits same to the user's mobile phone with the message “<short-code> payment req'd <amount $>” where:

<short-code> is a recognisable abbreviation of a biller; and

<amount $> represents the amount required to settle the biller's invoice.

In one exemplary embodiment, other data in the SMS to the user includes, due date and/or percentage variation with respect to the last bill. In one embodiment, the user is then required to pay the outstanding bill and does so at step 385 by transmitting a response SMS message to the system as “Pay <short-code> <amount $>”. Alternatively, at step 390, a further SMS message is transmitted to the user indicating that an automatic debit will be processed to settle the outstanding invoice in “x” days where the value of “x” may vary. At step 395, the user is then afforded “x−1” days in which to ensure that there are sufficient funds in the account to accommodate the automatic debit. Of course, the choice of either allowing an automatic direct debit to settle an account or require specific approval from the user can be determined by the account operating rules associated with the account. In any particular system, various users may elect either approach or perhaps different approaches, and it is envisaged that provider's of goods or services may offer incentives to users (such as a pre-arranged discount) to encourage users to allow entities to automatically access their account to directly debit funds to settle an outstanding invoice.

In other exemplary embodiments, when a user seeks to settle a bill or invoice, a third party is authorised to transfer value into the user's payment account to ensure that they have sufficient funds to fully settle the bill or invoice. Alternatively, a mechanism may be provided to enable a third party to authorise transfer of value to a user's on-line account to effect payment of a bill or invoice with a real time authorisation arrangement being effected to ensure that the value transferred by the third party to the user's account is used to settle the outstanding bill or invoice.

Irrespective of the payment arrangement effected for transfers of value from a user's account to any other account, users will most likely seek to check their account balances from time to time. In one exemplary embodiment, users are provided with the facility to check the balance of any of their accounts by transmitting an SMS message to the account operating system with a short code identifying the account for which a balance is required. The amount of the balance is then transmitted to the user in a return SMS message.

The format of such a query would likely be:
SMS Balance <short code>;

Where the <short code> in this instance represents the linked account for which the user requires a balance report. Alternatively, a balance query without a corresponding <short code> could be used to obtain the balance of a default linked account that is pre-identified by a user established account operating rule or alternatively, such a request could provide an overall balance of all the user's linked accounts. Similarly, with the requisite authority provided, balance requests of third party linked accounts could be requested and reported to a user.

In the above described exemplary embodiments, the user is provided with, or requests, a balance of an account. However, in some instances, users may prefer to simply transmit a request to pay a bill or invoice without first receiving an indication of the balance outstanding. For example, a user may prefer to establish account operating rules that allow them to transmit a message to pay a bill or invoice without first establishing the balance of the account from which value will be transferred to settle the invoice. Thereafter, upon receiving an invoice, a user may transmit an SMS message “Pay <short code> <amount $>” where the <short code> identifies the biller and the destination account to which value will be transferred and the <amount $> represents the value. This particular arrangement would be useful for users that regularly pay their bills and upon receipt of a new bill with an amount, the user may elect to simply pay the bill with the knowledge that the source account from which value will be transferred has sufficient funds to cover settlement of the bill.

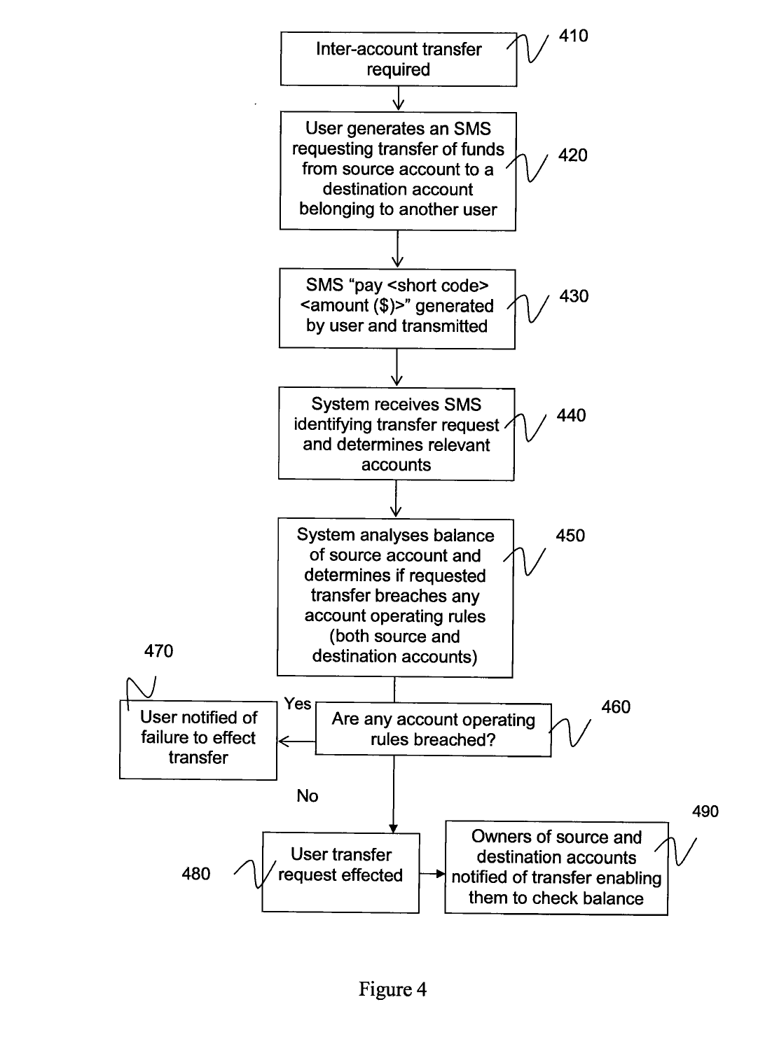

With reference to FIG. 4, the method steps associated with an inter-account transfer is detailed wherein a user may transfer funds from an account to the account of another user where a payment account for that other user has already been established as a separate payment account. At step 410, a user determines the requirement for an inter-account transfer to another entity with whom they have a pre-existing payment account. This situation could arise where a user needs to make a single payment to another individual. For example, if a user requires a personal loan in the form of cash, they may need to transfer funds to the person from whom they are obtaining the cash from. Another example would be the instance where a user needs to pay for the services of a babysitter or a handyman and they discover that they do not have any ready cash available or would prefer not to be obligated to ensure that they have ready cash available to effect payment. In these instances, the user may elect to transfer funds from of their on-line payment account to the on-line account of the other entity or individual.

In the example of FIG. 4, at step 420, the user generates an SMS message requesting transfer of funds from a source account owned by the user to a destination account belonging to another user. At step 430, the SMS message “Pay <Short-code> <amount ($)>” or “Trn <short-code> <amount ($)>” is generated and transmitted by the user to the on-line account operating system. At step 440, the on-line account system receives the SMS message identifying the transfer request and determines the relevant source and destination accounts from the SMS message. In the example of FIG. 4, the <short-code> identifies the user to whom funds will be transferred and the <amount ($)> identifies the value to be transferred. The user seeking to transfer funds is identified by the mobile phone number from which the SMS message is transmitted to the system and in the event that a particular source account is not identified in the SMS message a default account is assumed as the source account from which funds will be transferred. Alternatively a source account may be identified in the SMS message.

At step 450, the on-line account system determines the balance of the source account and assesses whether the requested transfer of funds breaches any account operating rules with respect to both the source and destination accounts. Step 460 determines the course of action to follow depending upon whether or not any account operating rules have been breached. In the event that an account operating rule is breached by the requested transfer of funds, the method proceeds to step 470 where the user is notified of the failure to effect the requested transfer. However, in the event that none of the account operating rules are breached, the method proceeds to step 480 where the user transfer request is effected and subsequent to the transfer, the owners of the source and destination accounts may check their balance to verify the transfer of value (step 490). Alternatively, the account operating system may automatically generate an SMS to the owner of source and/or destination account to confirm the transfer.

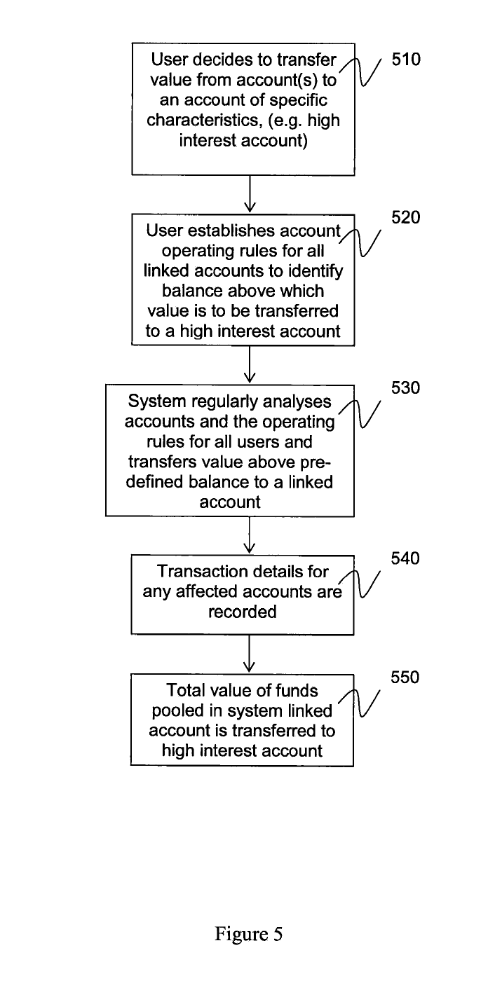

With reference to FIG. 5, another intra-account transfer arrangement is detailed wherein a user establishes an account operating rule for their accounts such that excess balances beyond threshold amounts (for example, amounts required to attend to immediate needs) are cleared from the accounts and transferred into a specific account for the purpose of achieving a rate of return on the excess funds for the time that they are not required. This decision on the part of a user occurs at step 510 and the establishment of account operating rules for all linked accounts that the user decides to establish a threshold balance occurs at step 520.

At step 530, the on-line account system regularly (or in real time) analyses the on-line accounts of all users and the operating rules therefor to determine for which accounts the balance threshold applies and the amount of funds in the account above the predefined balance. All amounts above a predefined threshold balance are transferred to a linked system account. At step 540, transaction details for any affected account are recorded in the account from which funds are debited. At step 550, the total value of funds pooled in the system linked account are transferred to a bank or licensed deposit taking entity operated high interest account for the purpose of obtaining a high rate of return for the period of time during which those funds remain in the high interest account. In one embodiment, account operating rules are also established to identify a low threshold balance below which a transfer of funds from the high interest account back to the user on-line account occurs. Of course, it is preferable that the high threshold balance is not the same as the low threshold balance in order to reduce the transaction activity between the high interest account and the user accounts. Further, the longer period of time that funds remain in the high interest account, the greater the return for users and hence there is an advantage for users to establish account operating rules that attempt to leave available funds in the high interest account for as long as possible. Of course, the transfer of interest payments to user accounts may be effected according to various arrangements such as regular direct debits or upon withdrawal of funds from the high interest account.

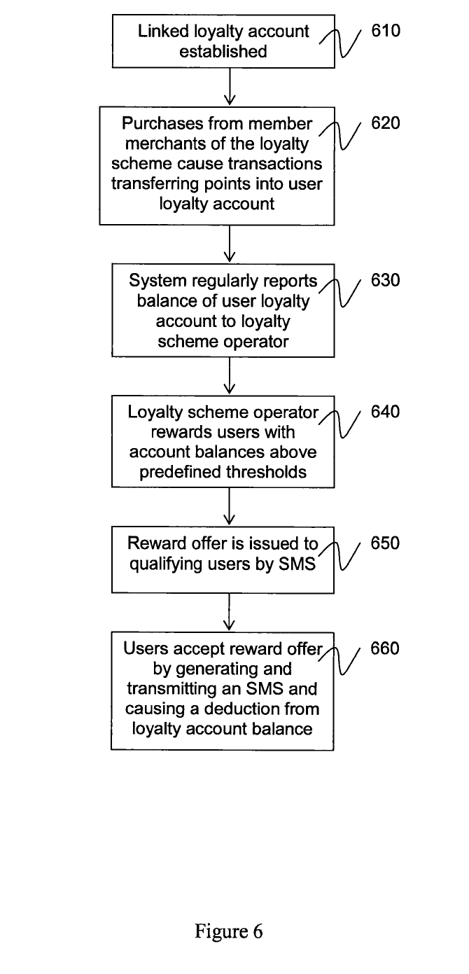

With reference to FIG. 6, another example of an inter-account transfer arrangement is described. In this example, a linked loyalty account is established by a user or a loyalty scheme operator at step 610. Once the loyalty account has been established, purchases that a user effects from member merchants of the loyalty scheme cause transactions transferring points into the user loyalty account (620).

Over a period of time where purchases are occurring, the on-line account system regularly reports the balance of user loyalty accounts to the relevant loyalty scheme operator (step 630). At step 640, the loyalty scheme operator rewards users with account balances above predefined threshold and at step 650, the loyalty scheme operator issues a reward offer to qualifying users by transmission of an SMS message to the qualifying users' mobile phone numbers.

Any of the qualifying users may accept the reward offer by generating and transmitting an SMS message to the loyalty scheme operator thus causing a deduction of value from their loyalty account balance in return for the reward (step 660). The user may be required to go to a particular merchant group to effect their reward purchase. Of course, the reward offered will depend upon the loyalty scheme operator but would typically include offers to receive merchandise in return for loyalty points.

FIGS. 2 to 6 are intended to convey some examples of inter and intra account transfers and the account operating rules that may be established to manage and control such transfers. As the account operating rules are inherently flexible, there is virtually no limitation upon the type or detail of rules as they are applied to users on-line accounts. Further examples of account operating rules for the purpose of controlling inter and intra account transfers that users could consider to be particularly convenient would include the following:
preventing value in an account being used for the purchase of particular types of goods or services such as those that may be identified by specific scheme merchant category codes;
preventing value in an account being used for the purpose of any goods from a particular merchant (as may be identified by a merchant ID (MID)); or
the establishment of a loyalty account where a purchase from a preferred list of participating member merchants (identified by a set of MID's) causes the transfer of a percentage of the purchase value or fixed reward to be credited to the loyalty account.
   Merchant/User Transactions Using Linked Accounts

The account structure and operation thereof afforded by the present invention further enables a range of advantages with respect to the transactions involving users and merchants. In this respect, the flexibility afforded by the account structure and the ability to associate specific account operating rules with individual accounts enables a range of merchant/user transactions to be implemented with relative ease and efficiency.

For example, in embodiments where the account operating system has an interface to the established EFTPOS network, users may have a device, such as a swipe card, associated with an account and may use the swipe card to access the funds in the account to make purchases from merchants equipped with an EFTPOS terminal. Of course, for merchants that do not provide credit, the user would need to maintain sufficient funds in the account associated with the swipe card to cover the cost of any purchases from these merchants.

In one exemplary embodiment, users are provided with a facility to load value into an account associated with a swipe card, or any other user device, by presenting the swipe card and cash to a merchant. Upon receiving the cash, the merchant processes the transaction to add the value provided to the merchant, less a transaction charge, to the users account associated with the swipe card. The user may then use the value in the account to make purchases or effect transfers from that account.

Whilst such an arrangement provides protection for merchants from a bad credit risk, a risk is incurred by the account system operator, or another third party, in the event that the merchant does not subsequently transfer the funds received from the user that was loaded into their account. To avoid the incurrence of this risk, in one exemplary embodiment, any transactions involving the loading of value into a user's account by a merchant requires the merchant to maintain a separate account with a positive balance for the purpose of transferring value to other user's account. In this embodiment, a merchant account operating rule is established to identify transactions that would incur a liability on a third party and for these transactions, the requisite amount is transferred from the merchant's pre-paid account to remove the liability that would otherwise be incurred. The operation of the account operating rule can occur without active participation in the part of the merchant and thus does not interrupt the usual transaction process that is effected by the merchant whilst simultaneously removing any liability on the part of the account system operator or any other third party.

Of course, for merchants to continue to provide a value load service to users they will need to maintain a positive balance in their pre-paid account that is established for this purpose. Another account operating rule could also be established for the merchant account to provide notifications in the event that the pre-paid account balance falls below a certain threshold thus advising the merchant of the potential inability to provide such a service to users. In the event of receiving such a notification, merchants can access their account and increase the value of the positive balance thus enabling them to continue to provide the relevant service to users.

This particular embodiment is useful in enabling newly established merchants without any previous credit history to commence provision of an entire range of services to users (including services that would usually incur a credit risk) by removing the credit risk and ensuring that the account system operator always has available funds to cover any transaction. In the event that the merchant fails to maintain a sufficient balance in their pre-paid account to cover the risk incurring services to users, the account system operator simply denies the processing of those types of transactions until the merchant's account balance is increased.

Purchasing Goods and/or Services from a Merchant with a Prepaid Account

In an exemplary embodiment, users could effect purchases by transmission of an SMS message of the type “Buy <short code>” where the <short code> identifies the product that the user wishes to purchase. The <short code> identifying the product is established by the account system operator or a user. The on-line payment account from which value would be transferred to effect payment could be nominated as a default account for the user. This payment account could be identified from the mobile phone No from which the user transmits the SMS message.

Further, in order to increase patronage at certain merchant's premises or on-line purchasing facilities for the purchase of goods and/or services, the merchant (or group of merchants as part of a merchant loyalty scheme) may offer loyalty reward points to customers for each purchase that is made at one of the member merchant premises or on-line facilities. With the account operating system of the present invention, the process of awarding loyalty points to a customer of the merchant (and user of the account operating system) is significantly simplified as compared with the maintenance of a separate loyalty account system. In the instance of the present invention, a linked user account for loyalty reward points for the merchant loyalty scheme allows the transaction relating to the purchase of an item to also effect the calculation and transfer of loyalty value into the loyalty account of the user.

Merchant Promotional Campaigns

Another example of the ability to more efficiently manage promotional campaigns occurs in the instance where manufacturers of specific items may offer prizes or rewards effectively as a game of chance when customers purchase their products. At the present time, these promotional offers generally require a user to retain the product packaging and to post same to the manufacturer for entry into a prize draw.

In the instance of the present invention, as product barcodes are scanned for purchase by a customer/user, the product codes may be analysed to determine those for which purchase acts to enter the customer into a prize draw. When the customer completes the purchase transaction by effecting payment by means of a pre-paid (or positive balance) account, the user's details may be captured as being a purchaser of a product for which a prize draw is pending. The purchaser's details may be included for the purpose of the prize draw and upon completing the prize draw at the appropriate time the winner of the prize draw may have their winnings automatically transferred into the account from which the product purchase was originally made.

This concept may also be extended to include manufacturer's rebates that may be made available from time to time to increase customer patronage of a particular manufacturer's products.

As the present invention may be embodied in several forms without departing from the essential characteristics, it should be understood that the above described embodiment should not be considered to limit the present invention but rather should be construed broadly within the spirit and scope of the invention. Accordingly, various modifications and equivalent arrangements are intended to be included within the spirit and scope of the invention.

Future patent applications may be filed on the basis of or claiming priority from the present application. It is to be understood that the following provisional claims are provided by way of example only, and are not intended to limit the scope of what may be claimed in any such future application.

We claim:

1. A method for a user to operate accounts with a user device when the user device is operably connected to a communications network, the user having at least one transaction account, the method including the steps of:
(a) the user establishing any number of linked transaction accounts and associating same with the at least one transaction account;
(b) the user establishing account operating rules for the at least one transaction account and any linked transaction accounts; and
(c) the user operating a user device to access the at least one transaction account and/or any linked transaction accounts.

2. A method for a user to effect account transactions with a user device operably connected to a communications network wherein the user has previously established at least one transaction account and any number o transaction account, the method including the steps of:
(a) the user establishing account operating rules for the at least one transaction account and/or any linked transaction accounts; and
(b) arranging at least one transfer of value to at least one account; and
(c) causing at least one transaction to occur in accordance with at least one account operating rule.

3. A method according to claim 1 or claim 2 wherein the transaction account and linked transaction accounts are on-line electronic accounts.

4. A method according to claim 1 or claim 2 wherein only one of the accounts includes all the necessary details of the user required for accurately establishing the bona-fides of same.

5. A method according to claim 1 or claim 2 wherein a linked transaction account is established by an entity other than the user.

6. A method according to claim 1 or claim 2 wherein the user is initially provided with one or more default linked accounts.

7. A method according to claim 1 or claim 2 wherein a user is initially provided with default transaction account operating rules upon the creation of a linked transaction account.

8. A method according to claim 1 or claim 2 wherein transaction account operating rules may be established and/or amended by operation of the user device.

9. A method according to claim 1 or claim 2 wherein the transaction account operating rules to effect any one or more of the following actions:
allow or disallow transactions;
allow or disallow intra-account transfers;
intra-account transfers;
allow or disallow inter-account transfers;
allow or disallow transfers between transaction accounts where the value of units in the respective accounts are of a different type;
allow or disallow transactions on the basis of the value of the transaction;
take any action necessary to enforce statutory or regulatory requirements; or
collect and record information relating to transactions to maintain a historical record of transactions.

10. A method according to claim 1 or claim 2 wherein the user device is any device operable to connect with, and transfer data over, a communications network.

11. A method according to claim 1 or claim 2 wherein the user device includes, but is not limited, to any one of the following:
a desk top computer;
a laptop computer;
a personal digital assistance;
a mobile phone; or
a cell phone.

12. A method according to claim 1 or claim 2 wherein the user device is connected to a communications network and provides the user with a facility to communicate over the communications network by any one or more of the following interfaces:
a web-enabled interface;
an interactive voice response system;
a short messaging service; or
a multi-media messaging service.

13. A user operable account transaction system enabling a user to access at least one transaction account with a user device, the at least one transaction account including links to any number of linked transaction accounts, the system including:
a user communication network gateway operable to provide network access to user devices;
a data storage means operably connected to the communication network for storing the user's account details, the links therebetween and operating rules for each account; and
at least one computer instruction processing device that receives a user account transaction request and executes same in accordance with at least one account operating rule.

14. A user operable account transaction system according to claim 13 wherein a computer instruction processing device maintains a balance of all individual user accounts and effects a transfer of all available user funds from the individual user accounts into at least one operating account.

15. A user operable account transaction system according to claim 14 wherein a request to withdraw funds from a particular user transaction account is recorded against that account and funds are withdrawn from the at least one operating account.

16. A computer program enabling a user to access a transaction account with a user device when the device is operably connected to a communications network, the transaction account including links to any number of linked transaction accounts, the computer program including:
computer instruction code providing access to a communications network for the user's device;
computer instruction code for authenticating the user accessing the network and upon successful authentication, providing the user with access to their transaction accounts;
computer instruction code enabling the user to establish or amend any account operating rules associated with any one or more of their transaction accounts; and
computer instruction code enabling the user to effect account transactions and applying the relevant transaction account operating rules with respect to any accounts involved in the transactions.

17. A method of offering a pre-established transaction account to a user, the transaction account accessible to the user by use of a user device when operably connected to a communications network, the method including the steps of:
establishing at least one transaction account for the user including identifying details pertaining to the user;
establishing default account operating rules that apply to the transaction account that are amendable by the user; and
forwarding an offer to the user to use of the transaction account.

18. A user communication network gateway operable to provide access between user devices and at least one data storage means that includes details pertaining to a user's at least one transaction account, any number of linked transaction accounts and operating rules pertaining thereto, wherein the communication network gateway provides access for users to effect transactions with respect to their at least one transaction account and/or any number of linked transaction accounts in accordance with any applicable account operating rules.

19. An operations server for effecting transactions in respect of a user's at least one transaction account and any number of linked transaction accounts, the operations server being connected to a communications network that is operable to receive user instructions in respect of their transaction account and/or any linked transaction accounts, said user instructions being effected in accordance with account operating rules that are associated with their transaction accounts.

20. A mobile communications device when used to access a transaction account, the mobile communications device then operably connected to a communications network, the transaction account including links to any number of linked transaction accounts establishable by the user, the mobile communications device operable by the user to effect any one or more of the following:
(a) establishing linked transaction accounts and associating same with the at least one transaction account;
(b) establishing account operating rules for the at least one transaction account and/or any linked transaction accounts; or
(c) accessing and effecting a transaction involving the at least one transaction account and/or any linked transaction accounts.
